(19) United States
(12) Patent Application Publication
(10) Pub. No.: US 2024/0237110 A1
(43) Pub. Date: Jul. 11, 2024

(54) COMMUNICATION APPARATUS, COMMUNICATION METHOD, AND STORAGE MEDIUM

(71) Applicant: CANON KABUSHIKI KAISHA, Tokyo (JP)

(72) Inventor: YUKI TSUJIMARU, Kanagawa (JP)

(21) Appl. No.: 18/615,800

(22) Filed: Mar. 25, 2024

Related U.S. Application Data
(63) Continuation of application No. PCT/JP2022/034794, filed on Sep. 16, 2022.

(30) Foreign Application Priority Data
Sep. 27, 2021 (JP) 2021-156853

(51) Int. Cl. H04W 76/15; H04W 84/12

(52) U.S. Cl. CPC H04W 76/15; H04W 84/12

(57) ABSTRACT

When a communication apparatus establishes connection with a different communication apparatus via a plurality of links, the communication apparatus transmits a Trigger frame being a Trigger frame defined by an Institute of Electrical and Electronics Engineers (IEEE) 802.11 standard, which is transmitted to the different communication apparatus, and in which a set of a Common Info field and a User Info field in the Trigger frame is included for each established link.

### CROSS-REFERENCE TO RELATED APPLICATIONS

This application is a Continuation of International Patent Application No. PCT/JP2022/034794, filed Sep. 16, 2022, which claims the benefit of Japanese Patent Application No. 2021-156853, filed Sep. 27, 2021, both of which are hereby incorporated by reference herein in their entireties.

### BACKGROUND OF THE INVENTION

### Field of the Invention

The present invention relates to a communication apparatus and a communication method for performing wireless communication.

### Background Art

In accordance with a recent increase in an amount of data to be communicated, the development of a communication technique such as a wireless local area network (LAN) has been advanced. As a major communication standard of the wireless LAN, an Institute of Electrical and Electronics Engineers (IEEE) 802.11 standard series has been known. The IEEE 802.11 standard series includes standards such as IEEE 802.11a/b/g/n/ac/ax. For example, in the IEEE 802.11ax being the latest standard, a technique of achieving high peak throughput up to 9.6 gigabit per second (Gbps) using orthogonal frequency-division multiple access (OFDMA), and also improving a communication speed under a congested situation is standardized (refer to PTL 1).

As a succeeding standard aimed at further throughput enhancement, improvement in frequency usage efficiency, and improvement in communication latency, a task group called IEEE 802.11be has started.

In the IEEE 802.11be standard, there has been considered Multi-Link communication by which one access point (AP) establishes a plurality of links with one station (STA) via a plurality of different frequency channels, and concurrently performs communication.

Further, in the IEEE 802.11ax, an AP transmits a Trigger frame to an STA as a communication partner to control upward communication of the STA.

### CITATION LIST

### Patent Literature

PTL 1: Japanese Patent Application Laid-Open No. 2018-50133

In the Multi-Link communication discussed in the IEEE 802.11be, it is assumed that communication is executed by applying different parameters between a first link and a second link.

Nevertheless, for example, in the case of transmitting a Trigger frame in a state in which Multi-Link communication is performed via the first link and the second link, it has been impossible to transmit parameters different for each link, via the conventional Trigger frame. In a case where different parameters are desired to be applied to the first link and the second link, it has thus been necessary to transmit a Trigger frame a plurality of times for each link, and there has been concern that communication overhead increases.

### SUMMARY OF THE INVENTION

In view of the above-described issues, the present invention is directed to suppressing communication overhead attributed to the transmission of a Trigger frame when Multi-Link communication is performed.

According to an aspect of the present invention, a communication apparatus includes an establishment unit configured to establish connection with a different communication apparatus via a plurality of links, and a transmission unit configured to transmit, when connection with the different communication apparatus is established by the establishment unit via the plurality of links, a Trigger frame being a Trigger frame defined by an Institute of Electrical and Electronics Engineers (IEEE) 802.11 standard, which is transmitted to the different communication apparatus, and in which a set of a Common Info field and a User Info field in the frame is included for each link established by the establishment unit.

Further features of the present invention will become apparent from the following description of exemplary embodiments with reference to the attached drawings.

### BRIEF DESCRIPTION OF THE DRAWINGS

FIG. 1 is a diagram illustrating a configuration of a network according to an exemplary embodiment of the present invention.

FIG. 2 is a block diagram illustrating a hardware configuration of a communication apparatus according to an exemplary embodiment of the present invention.

FIG. 3 is a block diagram illustrating a functional configuration of a communication apparatus according to an exemplary embodiment of the present invention.

FIG. 4 is a sequence diagram in which a communication apparatus 103 transmits data to a communication apparatus 102 according to an exemplary embodiment of the present invention.

FIG. 5 is a flowchart illustrating Trigger frame transmission performed by the communication apparatus 102 according to an exemplary embodiment of the present invention.

FIG. 6 is a diagram illustrating an example of a Trigger frame regarding a buffer status report (BSR) Request to be transmitted from the communication apparatus 102 to the communication apparatus 103 or 104 according to an exemplary embodiment of the present invention.

FIG. 7 is a diagram illustrating an example of an ACK frame to be transmitted from the communication apparatus 102 to the communication apparatus 103 or 104 according to an exemplary embodiment of the present invention.

FIG. 8 is a diagram illustrating an example of a Trigger frame to be transmitted

from the communication apparatus 102 to the communication apparatus 103 or 104 according to a first exemplary embodiment of the present invention.

FIG. 9 is a diagram illustrating an example of a Trigger frame to be transmitted from the communication apparatus 102 to the communication apparatus 103 or 104 according to the first exemplary embodiment of the present invention.

FIG. 10 is a diagram illustrating an example of a Trigger frame to be transmitted from the communication apparatus 102 to the communication apparatus 103 or 104 according to a second exemplary embodiment of the present invention.

FIG. 11 is a diagram illustrating an example of a Trigger frame to be transmitted from the communication apparatus 102 to the communication apparatus 103 or 104 according to a third exemplary embodiment of the present invention.

### DESCRIPTION OF THE EMBODIMENTS

Hereinafter, an exemplary embodiment of the present invention will be described in detail with reference to the accompanying drawings. The configurations described in the following exemplary embodiment are mere examples, and the present invention is not limited to the configurations illustrated in the drawings.

### Configuration of Wireless Communication System

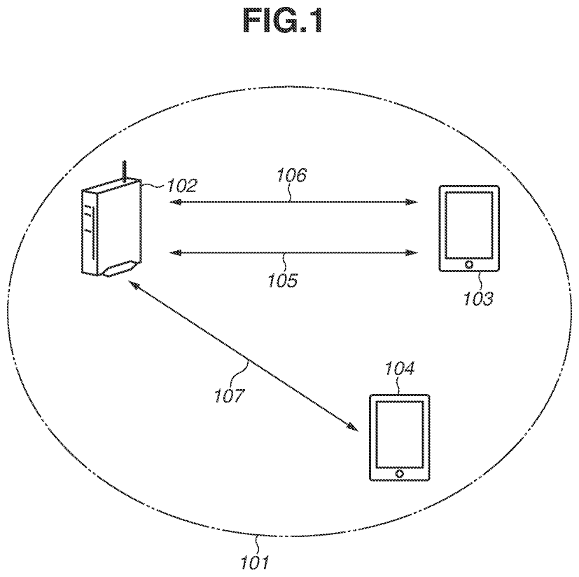

FIG. 1 illustrates a configuration of a network in which an access point (AP) 102 and stations (STAs) 103 and 104 according to the present exemplary embodiment participates. The AP 102 is a communication apparatus having a role of constructing a network 101. The network 101 is a wireless network. The STAs 103 and 104 are communication apparatuses having a role of participating in the network 101.

Each communication apparatus complies with the Institute of Electrical and Electronics Engineers (IEEE) 802.11be (extremely high throughput (EHT)) standard, and can execute wireless communication complying with the IEEE 802.11be standard, via the network 101. The EHT may be interpreted as an abbreviation for extreme high throughput. Each communication apparatus can execute communication in frequency bands including a 2.4-gigahertz (GHz) band, a 5-GHz band, and a 6-GHz band. The frequency bands to be used by each communication apparatus are not limited to these. For example, a different frequency band such as a 60-GHz band may be used. In addition, each communication apparatus can execute communication using bandwidths including a 20-megahertz (MHz) band, a 40-MHz band, an 80-MHz band, a 160-MHz band, and a 320-MHz band.

By executing orthogonal frequency division multiple access (OFDMA) communication complying with the IEEE 802.11be standard, the AP 102 and the STAs 103 and 104 can implement multi-user (MU) communication in which signals of a plurality of users are multiplexed. In the OFDMA communication, a part (resource unit (RU)) of divided frequency bands is allocated to each STA while avoiding overlapping each other. Carriers allocated to the respective STAs are orthogonal to each other. The AP can therefore concurrently communicate with a plurality of STAs.

In the IEEE 802.11ax standard, a method of transferring data from an STA to an AP in OFDMA is defined. It is first checked whether there is data to be transmitted by an AP to each STA. A frame checked at the time is referred to as a buffer status report (BSR) request. In response to this request, each STA conveys, to the AP, an amount of data planned to be transmitted to the AP. Information included in a frame conveyed at the time is referred to as a buffer status report (BSR). This method is an example, and there is also a method of conveying a BSR to the AP using another method. For example, a BSR may be transmitted with being included in a data frame or a control frame transmitted by an STA to the AP. Based on the BSR received from each STA, the AP allocates an STA for each sub channel, and transmits a frame serving as a starting point of data transmission. The frame serving as a starting point is referred to as a Trigger frame. The Trigger frame includes information indicating a sub channel via which each STA is to transmit data, and an ensured period. In accordance with the information included in the Trigger frame, an STA transmits data to the AP. In this manner, even in a crowded environment in which many STAs exist, the STAs can transmit data while avoiding collision. In addition, the AP 102 and the STAs 103 and 104 execute Multi-Link communication of performing communication by establishing a plurality of links via a plurality of different frequency channels. An AP that executes Multi-Link communication will also be referred to as an AP Multi-Link device (MLD). The frequency channels refer to frequency channels defined in an IEEE 802.11 series standard, via which wireless communication complying with an IEEE 802.11 series standard can be executed. In the IEEE 802.11 series standard, a plurality of frequency channels is defined for the respective frequency bands corresponding to the 2.4-GHz band, the 5-GHz band, and the 6-GHz band. In addition, in the IEEE 802.11 series standard, a bandwidth of each frequency channel is defined as 20 MHz. By bonding with a neighboring frequency channel, a bandwidth equal to or larger than 40 MHz may be used in one frequency channel. For example, the AP 102 can establish a first link 105 with the STA 103 via a first frequency channel in the 2.4-GHz band, and a second link 106 via a second frequency channel in the 5-GHz band, and execute communication via both links. In this case, the AP 102 maintains the second link 106 established via the second frequency channel, concurrently with the first link 105 established via the first frequency channel. In this manner, by establishing a plurality of links with the STA 103 that respectively correspond to a plurality of mutually different frequency channels, the AP 102 can enhance throughput in communication with the STA 103.

In the Multi-Link communication, the AP 102 and the STA 103 may establish a plurality of links with different frequency bands. For example, in addition to the first link 105 in the 2.4-GHz band and the second link 106 in the 5-GHz band, the AP 102 and the STA 103 may establish a third link in the 6-GHz band. Alternatively, the AP 102 and the STA 103 may establish links via a plurality of different channels included in the same frequency band. For example, the AP 102 and the STA 103 may establish the first link 105 via a 1 ch in the 2.4-GHz band, and the second link 106 via a 5 ch in the 2.4-GHz band. Links in the same frequency band and links in different frequency bands may be mixed. For example, in addition to the first link 105 established via the 1 ch in the 2.4-GHz band, and the second link 106 established via the 5 ch in the 2.4-GHz band, the AP 102 and the STA 103 may establish a third link via a 36 ch in the 5-GHz band. By establishing a plurality of connections with the STA 103 in different frequency bands, even in a case where a certain band is busy, the AP 102 can execute communication with the STA 103 in the other bands. This can prevent a decline in throughput in communication with the STA 103.

A plurality of links to be established by the AP 102 and the STA 103 in the Multi-Link communication are only required to be different at least in their frequency channels. A channel interval between frequency channels of a plurality of links to be established by the AP 102 and the STA 103 in the Multi-Link communication is only required to be larger than at least 20 MHz. In the present exemplary embodiment, the AP 102 and the STA 103 establish the first link 105 and the second link 106, but the AP 102 and the STA 103 may establish three or more links.

In the case of executing Multi-Link communication, the AP 102 constructs a plurality of wireless networks in such a manner as to correspond to the respective links. In this case, the AP 102 internally includes a plurality of APs, and operates the APs to construct the respective wireless networks. The APs included in the AP 102 may be one or more physical APs, or may be a plurality of virtual APs formed on one physical AP. In a case where a plurality of links is established in frequency channels belonging to a common frequency band, a wireless network common to the plurality of links may be used.

In the case of executing Multi-Link communication, the AP 102 and the STAs 103 and 104 divide one data and transmit the divided data to a partner apparatus via a plurality of links. Alternatively, the AP 102 and the STAs 103 and 104 may execute communication via one link, as backup communication of communication to be executed via the other link by transmitting the same data via a plurality of links. Specifically, the AP 102 transmits the same data to the STA 103 via a first link established via a first frequency channel, and a second link established via a second frequency channel. In this case, for example, even if an error occurs in communication executed via the first link, the same data is transmitted via the second link, and thereby the STA 103 can receive the data transmitted from the AP 102. Alternatively, the AP 102 and the STA 103 may use a different link depending on the type of a frame to be communicated or the type of data to be communicated. For example, the AP 102 may transmit a management frame via the first link, and transmit a data frame including data via the second link. Specific examples of the management frame include a Beacon frame, a Probe Request frame/Response frame, and an Association Request frame/Response frame. In addition to these frames, a Disassociation frame, an Authentication frame, a De-Authentication frame, and an Action frame are also referred to as management frames. The Beacon frame is a frame for reporting information regarding a network. The Probe Request frame is a frame for requesting network information. The Probe Response frame is a response to the Probe Request frame, and is a frame for providing network information. The Association Request frame is a frame for requesting connection. The Association Response frame is a response to the Association Request frame, and is a frame indicating a connection permission or error. The Disassociation frame is a frame for disconnecting connection. The Authentication frame is a frame for authenticating a partner apparatus, and the De-Authentication frame is a frame for stopping authentication of a partner apparatus and disconnecting connection. The Action frame is a frame for performing an additional function other than the above-described functions. The AP 102 and the STAs 103 and 104 transmit and receive a management frame complying with an IEEE 802.11 series standard. Alternatively, in the case of transmitting data on a captured image, for example, the AP 102 may transmit metainformation such as dates, parameters (aperture value and shutter speed) in image capturing, and position information via the first link, and transmit pixel information via the second link.

The AP 102 and the STAs 103 and 104 may also be enabled to execute multiple- input and multiple-output (MIMO) communication. In this case, the AP 102 and the STAs 103 and 104 include a plurality of antennas, and one transmits a different signal from each antenna using the same frequency channel. A reception side simultaneously receives all signals that have reached from a plurality of streams using the plurality of antennas, separates the signals from the streams, and decodes the signals. By executing MIMO communication in this manner, the AP 102 and the STAs 103 and 104 can communicate a larger amount of data during the same time as compared with a case where the MIMO communication is not executed. In addition, the AP 102 and the STAs 103 and 104 may execute MIMO communication via a part of links in the case of performing Multi-Link communication.

In addition, the AP 102 and the STAs 103 and 104 comply with the IEEE 802.11be standard, but may additionally comply with at least any one of legacy standards, which are standards formulated earlier than the IEEE 802.11be standard, and succeeding standards of the IEEE 802.11be. The legacy standards refer to the IEEE 802.11a/b/g/n/ac/ax standards. In the present exemplary embodiment, at least any one of the IEEE 802.11a/b/g/n/ac/ax/be standards and the succeeding standards is called an IEEE 802.11 series standard. In addition to the IEEE 802.11 series standards, the AP 102 and the STAs 103 and 104 may comply with other communication standards such as Bluetooth®, near field communication (NFC), an ultra wide band (UWB), ZigBee, and multi band OFDM alliance (MBOA). Examples of the UWB include a wireless universal serial bus (USB), wireless 1394, and Winners Information Network (WiNET). The AP 102 and the STAs 103 and 104 may also comply with a communication standard of wired communication of a wired local area network (LAN) or the like.

Specific examples of the AP 102 include a wireless LAN router, and a personal computer (PC), but the AP 102 is not limited to these. The AP 102 may be any communication apparatus as long as the communication apparatus can execute Multi-Link communication with a different communication apparatus. The AP 102 may also be an information processing apparatus such as a wireless chip that can execute wireless communication complying with the IEEE 802.11be standard. In addition, specific examples of the STAs 103 and 104 include a camera, a tablet, a smartphone, a PC, a mobile phone, and a video camera, but the STAs 103 and 104 are not limited to these. The STAs 103 and 104 may be any communication apparatus as long as the communication apparatus can execute Multi-Link communication with a different communication apparatus. The STAs 103 and 104 may also be an information processing apparatus such as a wireless chip that can execute wireless communication complying with the IEEE 802.11be standard. The network illustrated in FIG. 1 is a network including one AP and one STA, but the number of APs and the number of STAs are not limited to these. In addition, an information processing apparatus such as a wireless chip includes an antenna for transmitting a generated signal.

In the present exemplary embodiment, the AP 102 is an access point, and the STAs 103 and 104 are stations, but the configuration is not limited to this. All of the AP 102 and the STAs 103 and 104 may be stations. In this case, although the AP 102 is a station, the AP 102 operates as an apparatus having a role of constructing a wireless network for establishing a link with the STAs 103 and 104.

### Configuration of AP and STA

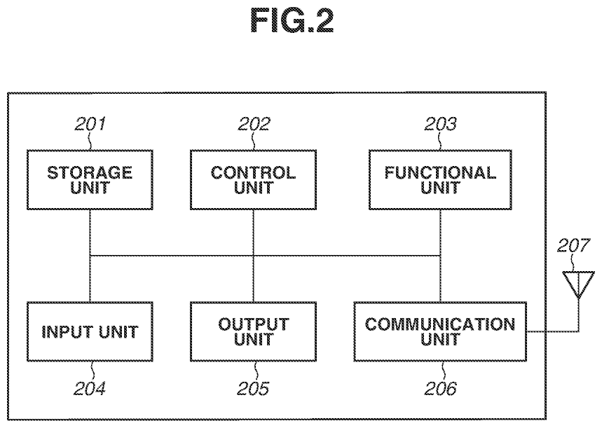

FIG. 2 illustrates a hardware configuration example of the AP 102 according to the present exemplary embodiment. The STAs 103 and 104 can also have a similar configuration. The AP 102 includes a storage unit 201, a control unit 202, a functional unit 203, an input unit 204, an output unit 205, a communication unit 206, and an antenna 207.

The storage unit 201 includes one or more memories such as a read only memory (ROM) and a random access memory (RAM), and stores computer programs for performing various operations to be described below and various types of information such as communication parameters for wireless communication. Aside from memories such as a ROM and a RAM, a storage medium may be used, such as a flexible disk, a hard disk, an optical disk, a magneto-optical disk, a compact disk read only memory (CD-ROM), a CD recordable (CD-R), a magnetic tape, a nonvolatile memory card, or a digital versatile disk (DVD), as the storage unit 201. The storage unit 201 may also include a plurality of memories.

The control unit 202 includes, for example, one or more processors such as a central processing unit (CPU) and a micro processing unit (MPU). The control unit 202 controls the entire AP 102 by executing computer programs stored in the storage unit 201. The control unit 202 may control the entire AP 102 in cooperation with computer programs and an operating system (OS) stored in the storage unit 201. The control unit 202 also generates data and signals (radio frames) to be transmitted in the communication with a different communication apparatus. The control unit 202 may also include a plurality of processors such as multi-core processors, and control the entire AP 102 using the plurality of processors.

The control unit 202 controls the functional unit 203 to execute predetermined processing such as wireless communication, image capturing, printing, and projection. The functional unit 203 is hardware for the AP 102 to execute the predetermined processing.

The input unit 204 receives various operations from the user. The output unit 205 performs various outputs to the user via a monitor screen or a speaker. Here, the output performed by the output unit 205 may be display on the monitor screen, voice output by the speaker, or vibration output. In addition, both the input unit 204 and the output unit 205 may be implemented by one module like a touch panel. The input unit 204 and the output unit 205 may each be formed integrally with or separately from the AP 102.

The communication unit 206 controls wireless communication complying with the IEEE 802.11be standard. The communication unit 206 may also control wireless communication complying with other IEEE 802.11 series standards in addition to the IEEE 802.11be standard. The communication unit 206 may also control wired communication via a wired LAN. The communication unit 206 controls the antenna 207 to transmit and receive signals for wireless communication that have been generated by the control unit 202. In a case where the AP 102 including a plurality of communication units 206 establishes a plurality of links in Multi-Link communication, one communication unit 206 establishes at least one link. Alternatively, the AP 102 may establish a plurality of links using one communication unit 206. In this case, the communication unit 206 executes communication via a plurality of links by switching, in a time division manner, a frequency channel via which the communication unit 206 operates.

In a case where the AP 102 complies with an NFC standard, a Bluetooth standard, and the like in addition to the IEEE 802.11be standard, the communication unit 206 may control wireless communication complying with these communication standards.

In a case where the AP 102 can execute wireless communication complying with a plurality of communication standards, communication units and antennas that correspond to the respective communication standards may individually be included. The AP 102 communicates data, such as image data, document data, and video data, with the STAs 103 and 104 via the communication unit 206. The antenna 207 may separately be formed from the communication unit 206, or may be formed as one module together with the communication unit 206.

The antenna 207 is an antenna that can execute communication in the 2.4-GHz band, the 5-GHz band, and the 6-GHz band. In the present exemplary embodiment, the AP 102 includes one antenna, but may include a plurality of antennas. Alternatively, the AP 102 may include different antennas for the respective frequency bands. In a case where the AP 102 includes a plurality of antennas, the AP 102 may also include communication units 206 corresponding to the respective antennas.

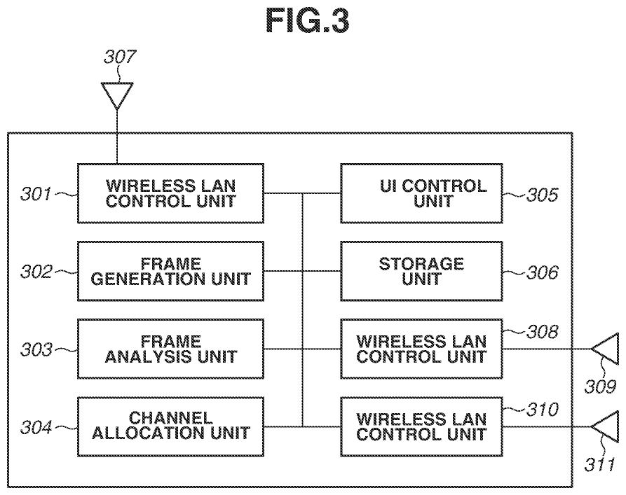

FIG. 3 is a block diagram illustrating a functional configuration of the AP 102 according to the present exemplary embodiment. The STAs 103 and 104 can have a similar configuration. In this example, the AP 102 includes three wireless LAN control units 301, 308, and 310. The number of wireless LAN control units is not limited to three, and may be one or two. In contrast, the number of wireless LAN control units may be four or more. The AP 102 further includes a frame generation unit 302, a frame analysis unit 303, a channel allocation unit 304, a user interface (UI) control unit 305, a storage unit 306, and wireless antennas 307, 309, and 311.

The wireless LAN control units 301, 308, and 310 each include an antenna and a circuit for transmitting and receiving radio signals to and from a different wireless LAN apparatus, and a program for controlling these. The wireless LAN control unit 301 executes communication control of a wireless LAN based on a frame generated by the frame generation unit 302, in accordance with the IEEE 802.11 standard series.

The frame generation unit 302 generates a wireless control frame to be transmitted by the wireless LAN control unit 301. The frame generated by the frame generation unit 302 can be transmitted by the wireless LAN control unit 308 or 310 in some cases. The content of a wireless control frame to be generated by the frame generation unit 302 may be restricted based on a setting stored in the storage unit 306. The content of the wireless control frame may alternatively be changed based on a user setting from the UI control unit 304.

The frame analysis unit 303 interprets frames received by the wireless LAN control units 301, 308, and 310, and reflects the content in the wireless LAN control units 301, 308, and 310. Whichever control unit receives a frame, it is possible to control even a wireless LAN control unit that has not received the frame by putting the frame through the frame analysis unit 303 once.

The channel allocation unit 304 makes a determination to appropriately allocate a channel via which an AP and an STA execute communication, when an instruction is issued to execute communication with a communication partner or communication with an STA. In accordance with the allocation determined at the time, communication is executed via a channel via which an AP 102 and an STA 104 execute communication, or a sub channel defined in the channel, for example.

The UI control unit 305 includes hardware components that are related to a user interface, such as a touch panel or a button for receiving an operation on an AP that is performed by the user (not illustrated) of the AP, and a program for controlling these. The UI control unit 305 also has a function for presenting information to the user, such as the display of images or voice output, for example.

The storage unit 306 is a storage device that can include a ROM and a RAM for storing programs and data for operating an AP.

### First Exemplary Embodiment

In the present exemplary embodiment, the AP 102 and the STA 103 execute Multi-Link communication. In a case where the OFDMA is employed as a communication method and the STA 103 transmits data to the AP 102, the STA 103 transmits data based on a Trigger frame from the AP 102 that serves as a starting point.

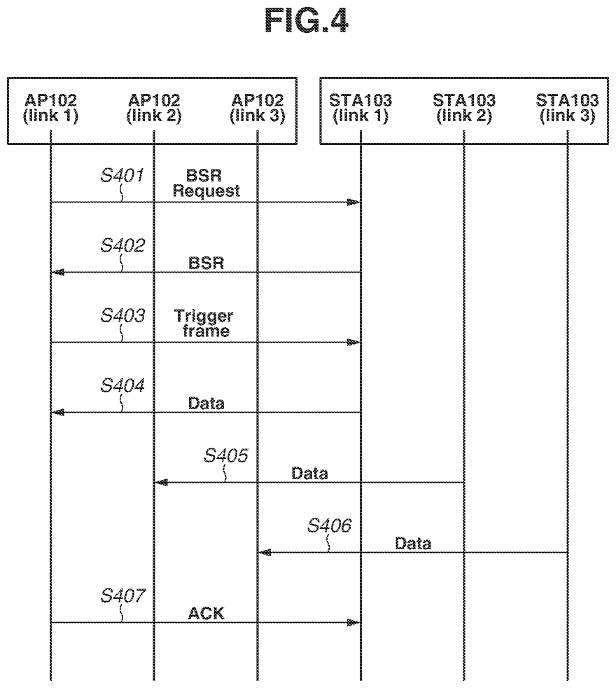

FIG. 4 is a sequence diagram illustrating an example of processing to be executed when the AP 102 receives data from the STA 103.

First of all, in step S401, the AP 102 transmits a buffer status report (BSR) Request to identify an amount of data to be transmitted to each connected STA. A BSR Request to be transmitted at the time may be issued for each link, but it is desirable that a BSR Request is issued only via a representative link. By transmitting a BSR Request only via a certain one link, a different communication device becomes able to make efficient use of a frequency band of links via which a BSR Request is not transmitted, and it also becomes possible to reduce power consumption of the AP 102 itself.

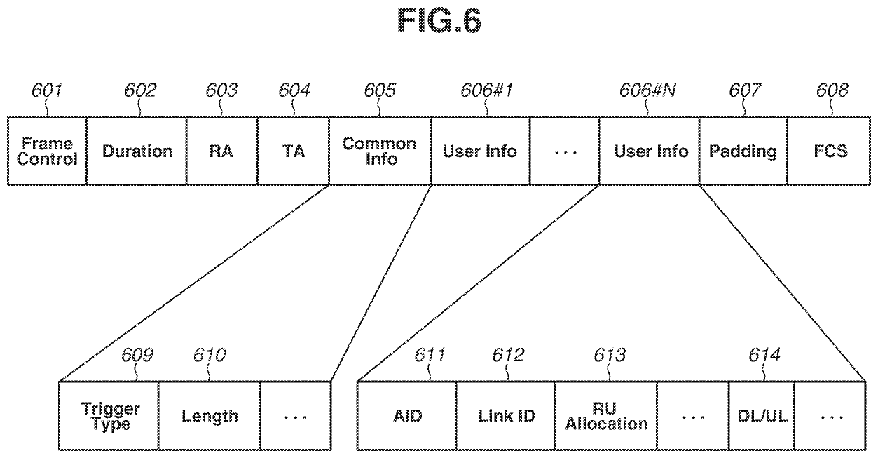

FIG. 6 illustrates an example of a frame format of a BSR Request transmitted in step S401. Specifically, fields from a Frame Control field 601 to a Common Info field 605 are used.

Table 1 indicates the correspondence between a subfield value and a trigger type that is stored in a Trigger Type.

TABLE 1

| Subfield value | Trigger type |
|---|---|
| 0 | Basic |
| 1 | Beamforming Report Poll (BFRP) |
| 2 | MU-BAR |
| 3 | MU-RTS |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8 | Multi-Link Trigger |
| 9-15 | reserved |

By setting a Trigger Type subfield 609 in the Common Info field 605, in a subfield value 4 shown in Table 1, it is indicated that a corresponding frame is a BSR Request frame. In the BSR Request frame, a value of a Length subfield 610 is set to 0, and a User Info field is not included. A Padding field 607 and a frame check sequence (FCS) field 608 follow the Common Info field 605. The length of a following subfield may be provided in the Length subfield 610. In this case, a field indicating a number of a channel or a link via which a BSR is requested may be provided posterior to the Length subfield 610.

If the STA 103 receives a BSR Request from the AP 102 in step S401, the STA 103 transmits, in step S402, a BSR to the AP 102. A BSR to be transmitted at the time may be transmitted for each link, but it is desirable that a BSR is transmitted only in a representative link. In FIG. 4, a Link 1 is set as a representative link. It is desirable that a link via which a BSR is transmitted to the AP 102 at the time is a link via which a BSR Request is received. This is because there is a high possibility that the AP 102 waits to receive a BSR via a link via which a BSR Request has been received. By transmitting a frame only via a representative link, a different communication device becomes able to make efficient use of a frequency channel used in links other than the representative link. It is also possible to reduce power consumed when the STA 103 performs transmission.

By a BSR to be transmitted at the time, a buffer size of standby data planned to be transmitted may be transmitted for each link, or a total value of buffer sizes of standby data pieces that are planned to be transmitted via the links may be transmitted. A BSR Request may include an instruction indicating whether to return a buffer size total value of data pieces planned to be transmitted via the links, or return a value of a buffer size of each link. For example, by providing a BSR Policy subfield posterior to the Length subfield 610, in a case where a value is 0, a buffer size of each link may be requested. In a case where a value is 1, buffer sizes of data pieces planned to be transmitted via the all links may be requested.

The BSR may be received using another method. For example, the AP 102 may receive a value of a BSR attached to data transmitted by the STA 103 in the past, and analyze the value. The BSR is indicated by a QoS Control field of a MAC HEADER. The zeroth to third bits of QoS indicate a Traffic Identifier (TID) of data, and the eighth to 15th bits indicate a Queue Size. The Queue Size includes a size of data planned to be transmitted by an STA to an AP. The BSR may be indicated in another way. For example, the BSR is sometimes indicated by an HT Control field. By setting zeroth to first bits to 1, the HT Control field indicates that the value is an operation value of the IEEE 802.11ax. This may indicate that the value is an operation value of the IEEE 802.11be, by setting the zeroth to second bits to 1, and may shift to the details of the operation value, which will be described below.

The operation value is classified into a four-bit Control ID and Control Information. When the four-bit Control ID is 3, it is indicated that Control Information is a BSR. In a case where a Control ID is a BSR, Control Information includes ACI Bitmap, Delta TID, ACI High, Scaling Factor, Queue Size High, and Queue Size All. Here, it is possible to convey, to a communication partner, a more detailed buffer size of a transmitted data than that transmitted using the QoS Control field. For example, the ACI Bitmap subfield uses four bits, and includes information indicating a TID of data. In the Scaling Factor field, a scale of the Queue Size can be indicated. In the High Queue Size field, a Queue Size of a TID with the highest priority is indicated, and in the Queue Size All field, a Queue Size obtained by combining all TIDs is indicated. By adding a Link field to here, it is also possible to transmit a Queue Size of each link.

If the AP 102 receives a BSR from an STA in step S402, in step S403, the AP 102 allocates each STA to an appropriate RU based on the received BSR, and transmits a Trigger frame based on this.

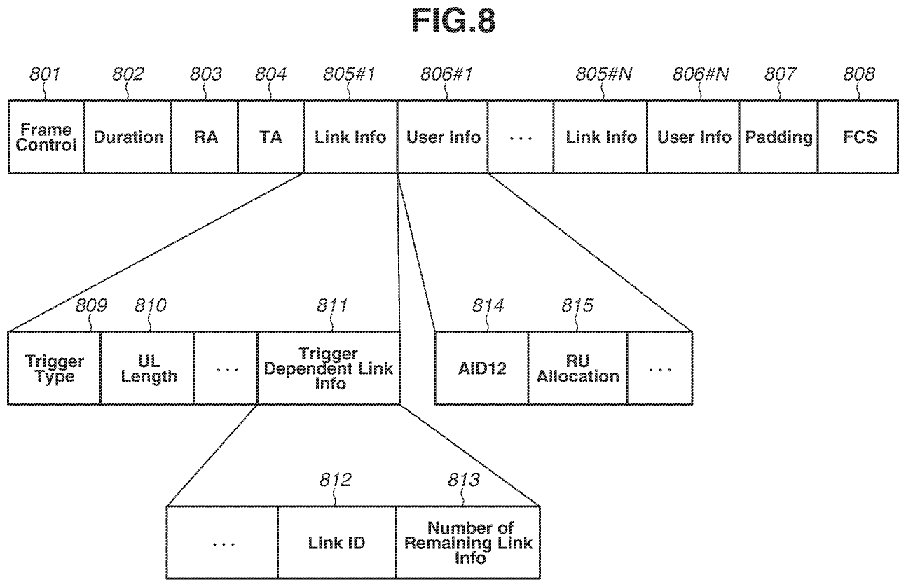

FIG. 8 illustrates an example of a frame format of a Trigger frame to be transmitted in step S403. In this frame, information regarding a link for an STA transmitting data is stored in a Link ID 812 of a Link Info field 805.

The Trigger frame includes, from the head, a Frame Control field 801, a Duration field 802, an RA field 803, a TA field 804, the Link Info field 805, a User Info field 806, a Padding field 807, and an FCS field 808.

A four-bit Trigger Type subfield 809 in the Link Info field 805 designates the type of a trigger to be provided by the Trigger frame. A UL Length subfield 810 in the Link Info field 805 indicates a communication period common to all STAs. The communication period corresponds to an amount of data that can be transmitted and received by each STA.

When a Trigger type subfield value shown in Table 1 is 8, it is indicated that the Trigger frame is a frame for issuing an instruction to transmit data held by an STA that has established connection with an AP, to the AP in Multi-Link communication.

The Link ID subfield 812 included in the Link Info field 805 includes information regarding a link for an STA that has established connection with the AP 102, transmitting data. For example, in a case where an instruction is issued to transmit data via the first link operating in the 5 ch in the 2.4-GHz band, 1 is stored as a value of the Link ID subfield 812. In this manner, link information is stored in the Link ID subfield 812. A link number is allocated by the AP 102 when an AP and an STA establish connection, and given to the STA 103. The Link ID subfield 812 prepares three bits. The number of bits to be prepared is not limited to this. For example, a subfield may be a two-bit, five-bit, or eight-bit subfield. A channel number may be allocated as a value of this subfield. For example, in a case where an instruction is issued to transmit data from the STA 103 to the AP 102 in the 5 ch in the 2.4-GHz band, a value may be set to 5. In a case where channel information is used as a subfield value in this manner, eight bits are prepared for a subfield. A value to be given here may be a value associated with a band. For example, the 2.4-GHz band is associated with 1, the 5-GHz band is associated with 2, and the 6-GHz band is associated with 3. In this case, in a case where allocation is performed in the 2.4-GHz band, a channel subfield is set to 1. In this case, it is sufficient that two bits are prepared for a subfield.

A Number of Remaining Link Info subfield 813 includes the remaining number of sets of a Link Info field and a User Info field. For example, if a value of the Number of Remaining Link Info subfield 813 is 3, it is indicated that the set of the Link Info field and the User Info field is followed by three sets of Link Info and User Info.

If the value of the Number of Remaining Link Info subfield 813 is 0, it is indicated that the User Info field following the Link Info field is not followed by a set of Link Info and User Info. In this case, it is indicated that the Padding field 807 appears after the User Info field. The Number of Remaining Link Info subfield 813 prepares eight bits. The number of bits to be prepared is not limited to this. For example, the Number of Remaining Link Info subfield 813 may be a two-bit or five-bit subfield.

In addition, the Link Info field 805 includes information such as Carrier Sense (CS) Required, an Up Link (UL) Band Width (BW), and AP Transmit (Tx) Power. Here, the CS Required includes information indicating whether or not carrier sense by an STA is required, the UL BW includes information indicating a bandwidth of a channel to be used when an STA transmits data to an AP, and the AP Tx Power includes information indicating transmission output of an AP that transmits a Trigger frame. By preparing the Link Info field 805 for each link with which connection has been established, an AP can, for example, designate the execution or non-execution of carrier sense for each link, or designate a bandwidth for each link.

The above-described information included in the Link Info field 805 is not limited to the above-described information as long as the information is included in Common Info of a Trigger frame that is defined by the IEEE 802.11ax. In other words, it is sufficient that at least one of pieces of information included in Common Info of a Trigger frame that is defined by the IEEE 802.11ax is included in the Link Info field 805.

The User Info field 806 is a field corresponding to each STA that establishes connection with an AP. The same number of sets of the Link Info field 805 and the User Info field 806 as the number of STAs that establish connection are continuously transmitted.

The User Info field 806 includes an Association ID (AID) 12 being an identifier, and RU Allocation 313. The AID12 is indicated by 12 bits. When an AID being identification information allocated when connection is established is stored in the AID12, lower 12 bits of the AID are stored. Thus, a subfield of the AID12 is stipulated as an AID 12 subfield in Table 2.

The User Info field 806 includes the AID12 subfield 814, and Table 2 indicates the correspondence between a value of the AID12 subfield 814 and the meaning thereof.

TABLE 2

| AID12 subfield | Content |
|---|---|
| 0 | Resource Unit (RU) is for random access of |
| | connected STA |
| 1-2007 | RU is allocated to STA that has been connected |
| | and has equal AID value |
| 2008-2044 | Reserved |
| 2045 | RU is for random access of unconnected STA |
| 2046 | RU is not allocated to STA |
| 2047-4094 | Reserved |
| 4095 | Head of padding field |

In a case where the AID12 subfield includes a value in the range of 1-2007, it is indicated that corresponding User Info is User Info for an STA that has an equal value of the AID12 subfield to an AID allocated when connection has been established. In a case where 2045 is included in the AID12 subfield, it is indicated that corresponding User Info is User Info for an STA that has not established connection and does not have an allocated AID.

In the present exemplary embodiment, a value of the AID12 subfield is a value allocated by the AP 102 to the STA 103, and is 1, for example.

The RU Allocation subfield 815 defines an RU and a tone size of a corresponding STA. The RU Allocation subfield 815 prepares eight bits.

An RU being a frequency component to be used when the STA 103 transmits data to the AP 102 is allocated to the RU Allocation subfield 815. Table 3 indicates an example of a value of an RU to be allocated to the RU Allocation subfield 815.

Based on a combination of the Link ID subfield 812 and the RU Allocation subfield 815 that are paired, the STA 103 can recognize a channel frequency for transmitting data to the AP 102.

TABLE 3

| RU Allocation | Bandwidth to be | | |
|---|---|---|---|
| subfield | used | RU size | RU Index |
| 0-8 | 20 MHz, 40 MHz, | 26 | RU1 to RU9 |
| | 80 MHz, 80 + 80 | | |
| | MHz, 160 MHz | | |
| 9-17 | 40 MHz, 80 MHz, | 26 | RU10 to RU18 |
| | 80 + 80 MHz, 160 | | |
| | MHz | | |
| 18-36 | 80 MHz, 80 + 80 | 26 | RU19 to RU37 |
| | MHz, 160 MHz | | |
| 37-40 | 20 MHz, 40 MHz, | 52 | RU1 to RU4 |
| | 80 MHz, 80 + 80 | | |
| | MHz, 160 MHz | | |
| 41-44 | 40 MHz, 80 MHz, | 52 | RU5 to RU8 |
| | 80 + 80 MHz, 160 | | |
| | MHz | | |
| 45-52 | 80 MHz, 80 + 80 | 52 | RU9 to RU16 |
| | MHz, 160 MHz | | |
| 53, 54 | 20 MHz, 40 MHz, | 106 | RU1, RU2 |
| | 80 MHz, 80 + 80 | | |
| | MHz, 160 MHz | | |
| 55, 56 | 40 MHz, 80 MHz, | 106 | RU3, RU4 |
| | 80 + 80 MHz, 160 | | |
| | MHz | | |
| 57-60 | 80 MHz, 80 + 80 | 106 | RU5 to RU8 |
| | MHz, 160 MHz | | |
| 61 | 20 MHz, 40 MHz, | 242 | RU1 |
| | 80 MHz, 80 + 80 | | |
| | MHz, 160 MHz | | |
| 62 | 40 MHz, 80 MHz, | 242 | RU2 |
| | 80 + 80 MHz, 160 | | |
| | MHz | | |
| 63, 64 | 80 MHz, 80 + 80 | 242 | RU3, RU4 |
| | MHz, 160 MHz | | |
| 65 | 40 MHz, 80 MHz, | 484 | RU1 |
| | 80 + 80 MHz, 160 | | |
| | MHz | | |
| 66 | 80 MHz, 80 + 80 | 484 | RU2 |
| | MHz, 160 MHz | | |
| 67 | 80 MHz, 80 + 80 | 996 | RU1 |
| | MHz, 160 MHz | | |
| 68 | 80 + 80 MHz, 160 | 2*996 | RU1 |
| | MHz | | |

For example, in a case where a frequency channel to be used is 20 MHz and a value of the RU Allocation subfield 815 is 38, the second RU is allocated to the STA 103 among tone sizes of the sub channel that are allocated to 52. A plurality of RUs may also be allocated to the same STA. In a case where a plurality of RUs is allocated to the same STA, a different Link ID subfield or a different RU Allocation subfield with the same AID is allocated. Alternatively, a different RU Allocation subfield with the same AID and the same Link ID subfield is allocated. At this time, the User Info field 806 is prepared for each RU to be allocated. Another representation for allocating a plurality of RUs to one STA may be used. For example, a one-bit Cascaded subfield is prepared posterior to an AID subfield. In a case where this bit is set, a Cascaded subfield, a Link ID subfield, and an RU Allocation subfield continues again after the RU Allocation subfield 815. In a case where this bit is 0, the next subfield continues after this. In the case of this allocation method, it becomes possible to allocate a plurality of channels with a smaller number of bits. Even in a case where a bandwidth varies for each channel, it is possible to flexibly allocate an RU.

Nevertheless, this is an example, and another representation method may be used. In the present exemplary embodiment, a channel is also represented simultaneously, and thus a bandwidth to be used may also be limited to a unit of 20 MHz. In this case, it is sufficient that the RU Allocation subfield has four bits. A Cascaded subfield may also be prepared in the form of limiting the bandwidth to 20 MHz.

The frame format illustrated in FIG. 8 is an example, and the designation of a Link ID and an RU is not limited to this. For example, RUs may be allocated in ascending order of Link numbers. In this case, for example, in a case where a bandwidth of 40 MHz is provided in the 1 ch in the 2.4-GHz band and a 36 ch in the 5-GHz band, in a case where an RU size is further allocated only using 26, RUs are allocated as follows. Zero to 17 are allocated to the first to 18th RUs to be used in the 1 ch in the 2.4-GHz band. Eighteen to 36 are allocated to the 19th to 37th RUs to be used in the 36 ch in the 5-GHz band.

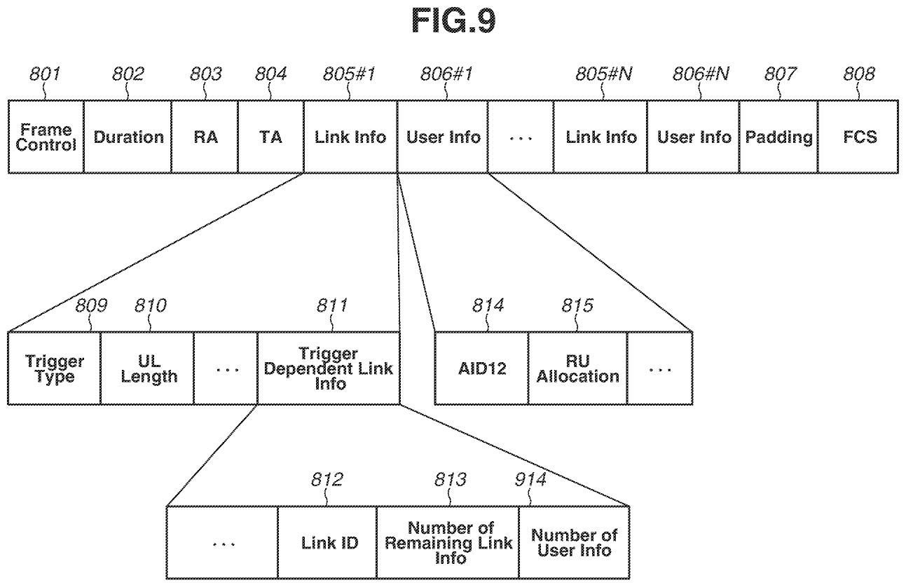

Furthermore, a Link Info field of a Trigger frame may also be defined as illustrated in FIG. 9. Here, a Number of User Info field 914 indicates the number of User Info fields corresponding to the Link Info field. The other fields of the Trigger frame are similar to those in the frame format illustrated in FIG. 8. By adding the Number of User Info field 914, one or a plurality of User Info fields following the Link Info field can refer to a parameter indicated by the Link Info field.

In a DL/UL subfield 614, it is designated whether subsequent data is to be transmitted or received by an STA. For example, in a case where a value is 0, the data is transmitted from an STA to an AP, and in a case where a value is 1, the data is transmitted from an AP to an STA.

The name of fields of the Trigger frame are not limited to the above-described names, and a different name may be used. Parameter information of each link is transmitted using a Link Info field, but a notification method is not limited to this. The parameter information may also be included in a field of a Trigger frame that complies with the IEEE 802.11ax. For example, information equivalent to a Link Info field may be included in a Common Info field. The order of subfields is not limited to the above-described order, and a different order may be used.

If each STA receives, in step S403, a Trigger frame transmitted by the AP 102, STAs transmit data in steps S404, S405, and S406 to the AP 102 in accordance with allocation.

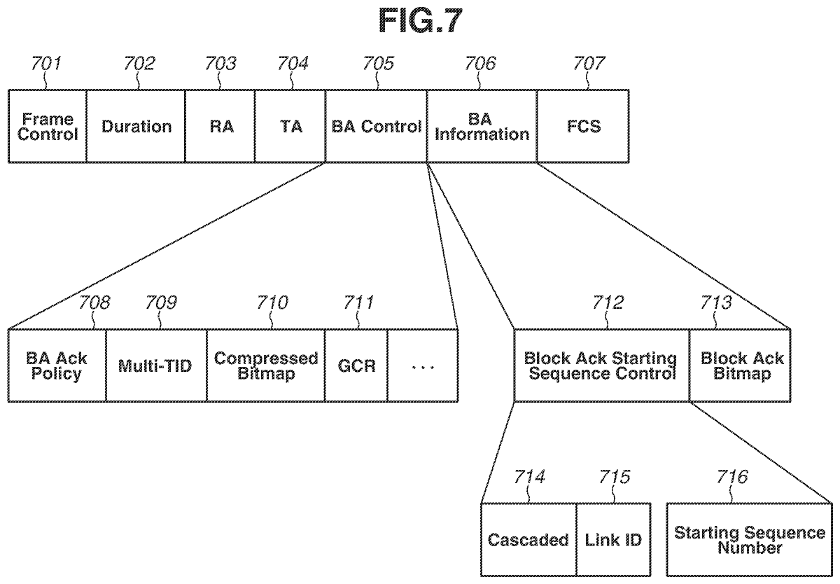

If the AP 102 receives, in step S407, data transmitted by the STA 103, the AP 102 transmits Acknowledgement (ACK) associated with the data, as a response. At this time, the AP 102 collectively transmits one ACK without transmitting ACK for each Link from which data has been received. FIG. 7 illustrates an example of a frame format of the ACK to be transmitted at this time. In the present exemplary embodiment, Block ACK (BA) is used as the ACK. This frame can collectively transmit Acks for a plurality of pieces of data.

Fields/subfields illustrated in FIG. 7 comply with the format defined in the IEEE 802.11ax.

The ACK includes, from the head, a Frame Control field 701, a Duration field 702, an RA field 703, a TA field 704, a BA Control field 705, a BA Information field 706, and an FCS field 707.

The BA Control field 705 includes a BA Ack Policy subfield 708, a Multi-TID subfield 709, a Compressed Bitmap subfield 710, and a Groupcast with retries (GCR) subfield 711.

Among the subfields, based on a combination of values of the Multi-TID subfield 709, the Compressed Bitmap subfield 710, and the GCR subfield 711, the type of BA is designated. Table 4 exemplifies the correspondence between each subfield and the type of BA.

TABLE 4

| | Compressed | | |
|---|---|---|---|
| Multi-TID | Bitmap | GCR | BA type |
| 0 | 0 | 0 | Basic |
| 0 | 1 | 0 | Compressed |
| 1 | 0 | 0 | Extended Compressed |
| 1 | 1 | 0 | Multi-TID |
| 0 | 0 | 1 | Reserved |
| 0 | 1 | 1 | GCR |
| 1 | 0 | 1 | Reserved |
| 1 | 1 | 1 | Reserved |

If a Multi-TID subfield value is 0, a Compressed Bitmap subfield value is 0, and a GCR subfield value is 0, it is indicated that BA ACK is Basic Ack.

The type of dedicated BA may also be provided. For example, when a Multi-TID subfield value is 0, a Compressed Bitmap subfield value is 0, and a GCR subfield value is 1, BA may be determined to be BA for the time of Multi-Link.

The configuration of the BA Information field varies depending on the type of BA. In a case where the type of BA is Basic, a Block Ack Starting Sequence Control subfield 712 and a Block Ack Bitmap subfield 713 are included.

The Block Ack Starting Sequence Control subfield 712 includes a Cascaded subfield 714, a Link ID subfield 715, and a Starting Sequence Number subfield 716. In a case where a value of the Cascaded subfield 714 is 1, this means that a BA Information field continues even after this. In a case where a value of the Cascaded subfield 714 is 0, the BA Information field is the last BA Information field. The Link ID subfield 715 designates a value of a Link number designated by the AP 102. For example, in a case where the Link number is 1, a value is set to 1. The Starting Sequence Number subfield 716 indicates a sequence number starting in the subsequent Block Ack Bitmap subfield 713. The Block Ack Bitmap subfield 713 indicates a received data frame. In a case where the third data counted from the sequence number indicated by the Starting Sequence Number subfield 716 has been received, a value of the third bit is set to 1. A bit corresponding to an unreceived sequence number is set to 0.

In this manner, in data communication starting from a Trigger frame, it is possible to collectively transmit a Trigger frame and Ack via one Link even in Multi-Link communication.

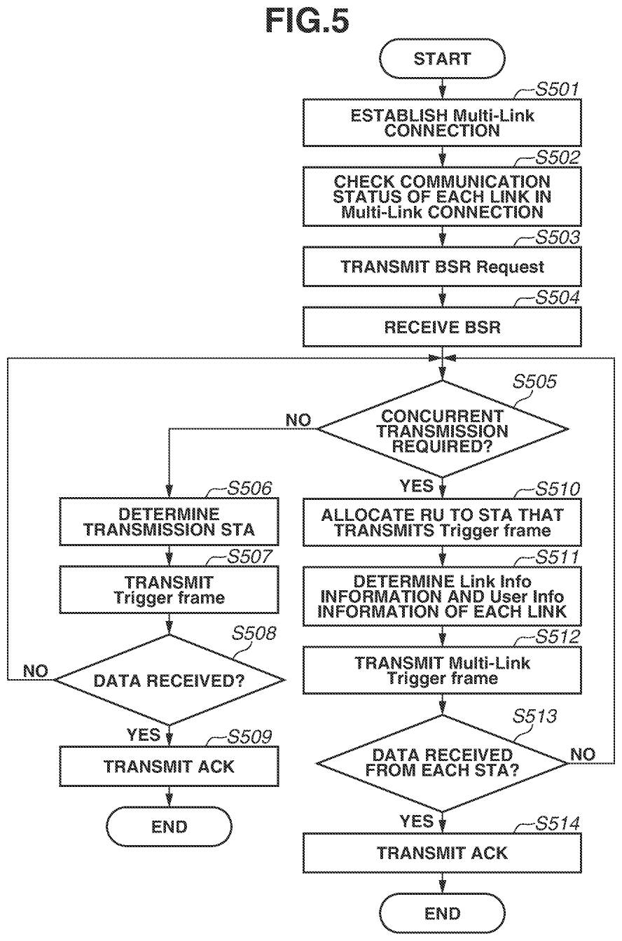

FIG. 5 is a flowchart illustrating a flow of processing to be performed by the control unit 202 executing a program stored in the storage unit 201 of the AP 102, when the AP 102 executes Multi-Link communication with the STA 103 and transmits a Trigger frame.

The processing in this flowchart is started when the AP 102 and the STA 103 establish connection.

First of all, in step S501, the AP 102 and the STA 103 establish connection via a plurality of links.

If the AP 102 and the STA 103 establish connection via a plurality of links in step S501, the control unit 202 checks, in step S502, a communication state regarding connection in Multi-Link communication, and the setting of each STA. The processing in step S502 may be executed when the connection processing is performed in step S501. Examples of parameters to be checked for each STA include a Min-Max rate of a communication speed, a communication bandwidth, a communication channel, MCS, and information regarding whether concurrent transmission and reception are executable. The AP 102 can thereby identify how much amount of data can be expected to be received when an RU is allocated to the STA 103.

In step S502, the control unit 202 checks a communication state regarding connection in Multi-Link communication, and the setting of each STA. Thereafter in step S503, the AP 102 transmits a BSR Request to identify an amount of data to be transmitted by each connected STA. This processing corresponds to the processing in step S401 of FIG. 4.

In step S504, the AP 102 receives a BSR being a response to the BSR Request transmitted to the STA 103 in step S503. In a case where there is data to be transmitted to the AP 102, the STA 103 transmits a BSR to the AP 102. Also in a case where there is no data to be transmitted to the AP 102, the STA 103 may transmit a BSR to the AP 102.

In step S505, the AP 102 determines whether data transmission and reception need to be concurrently performed based on the setting of each STA that has been checked in step S502, and an amount of standby data to be transmitted by the STA. For example, in a case where channels of links via which STAs connect to an AP are close, or in a case where an STA cannot concurrently execute data transmission via one link and execute data reception via the other link, data upload is to be concurrently performed in response to an instruction of the AP 102. In a case where communication channels to be used by a plurality of links are the 1 ch and a 3 ch in the 2.4-GHz band, mutual interference occurs and communication fails to be executed smoothly if a communication period shifts. Thus, communication that uses a Trigger frame is required. Alternatively, in a case where content of data is shared among a plurality of links, data transmission requires synchronization. Thus, data synchronization is considered to be achieved using a Trigger frame as one method of synchronization. In a case where content of data is shared among a plurality of links, it is considered that a sequence number of data is shared among a plurality of links, for example. In a case where a sequence number is transmitted using a value common to a plurality of links, it is necessary to identify an anteroposterior relationship of data when data is integrated. The transmission and reception of a Trigger frame are used as the reference of this. Received data and unreceived data are identified by using a unit from a certain Trigger frame to the next Trigger frame, integrating data within the unit, and rearranging data based on a sequence number.

In a case where it is determined in step S505 that a concurrent operation is required (YES in step S505), the processing proceeds to step S510. In step S510, the AP 102 allocates an RU to be used when data is transmitted to the AP 102, to a connected STA. As an allocation method, STAs may be equally divided based on allocated RUs. For example, in a case where the STA 103 and the STA 104 are connected to the AP 102, an RU size of 106 may be allocated to the STA 103 and an RU size of 106 may be allocated to the STA 104 in such a manner that the RU sizes of the STA 103 and the STA 104 become equal. Alternatively, an RU may be allocated in accordance with a ratio of upload data acquired based on a BSR. For example, in a case where there are 20 pieces of upload data of the STA 103 and 10 pieces of upload data of the STA 104, an RU size of 106 may be allocated to the STA 103 and an RU size of 52 may be allocated to the STA 104. Information regarding an RU allocated to an STA in step S510 is stored into an RU Allocation subfield of a frame format.

In a case where an RU to be allocated to an STA that transmits a Trigger frame is determined in step S510, in step S511, content of a Trigger frame to be transmitted is determined based on information regarding the STA. Specifically, content of a Link Info field and a User Info field is determined for each transmission target link based on information obtained in steps S502 and S504.

In the present exemplary embodiment, parameters of each link are designated in the Trigger frame based on a set of a Link Info field and a User Info field, but a parameter designation method is not limited to this.

In a case where a Trigger frame (hereinafter, uniform Trigger frame) unifying information regarding RUs to be allocated in a plurality of links is to be transmitted, in step S512, the uniform Trigger frame is transmitted in accordance with the allocated RU. This processing corresponds to the processing in step S403 of FIG. 4. A Trigger frame to be transmitted in step S512 is exemplified in FIG. 8. In step S513, data transmitted from each STA is received based on the uniform Trigger frame transmitted in step S512.

If the AP 102 receives data from the STA 103 in step S513, in step S514, the AP 102 transmits ACK indicating that data has been received. At this time, the AP 102 collectively transmits one ACK for data received via a plurality of links. The ACK transmitted in step S514 also corresponds to the ACK transmitted in step S407 of FIG. 4. If the AP 102 transmits ACK in step S514, this flowchart ends.

In a case where it is determined in step S505 that a concurrent operation is not required (NO in step S505), the processing proceeds to a flow of data transmission and reception for each link, and in step S506, the AP 102 determines an STA that transmits a Trigger frame. At this time, an STA to be allocated may be independently determined for each link channel to be used, or an STA that transmits a Trigger frame may be allocated across a plurality of links. For example, a case will be considered where the STA 103 establishes connection via the 5 ch in the 2.4-GHz band and the 36 ch in the 5-GHz band, and the STA 104 establishes connection via the 36 ch in the 5-GHz band. In a case where an STA is allocated independently for each channel under such a situation, in the 36 ch, for example, the RU size of 106 is allocated to the STA 103, and the RU size of 106 is allocated to the STA 104. Subsequently, in the 5 ch, an RU size of 242 is allocated to the STA 103. Furthermore, a case where an STA is allocated across a plurality of links will be considered. At this time, in the 36ch, the RU size of 242 is allocated to the STA 103. In the 5 ch, the RU size of 242 is allocated to the STA 104. In a case where data transmission and reception are managed for each link, that is to say, in a case where an STA is allocated independently for each link channel, it becomes unnecessary to achieve synchronization across links. Thus, it becomes unnecessary for a link with a faster communication speed to wait for a slow link, and it becomes possible to transmit and receive data more quickly.

In a case where, STA allocation in each link is determined in step S506, in step S507, a Trigger frame is transmitted via each link. In step S507, a Basic Trigger frame complying with the IEEE 802.11ax is used. That is, 0 described in Table 1 is stored into a Trigger Type in the frame format illustrated in FIG. 6.

In step S508, it is determined whether data has been received from an STA in accordance with the Trigger frame. In a case where it is determined in step S508 that data has been received (YES in step S508), the processing proceeds to step S509. In step S509, ACK that is based on the received data is transmitted. In step S509, the ACK is transmitted based on data received via each link. In addition, the ACK to be transmitted at this time complies with ACK defined in the IEEE 802.11. As described in step S514, Block Ack common to a plurality of links may be transmitted. If data reception properly ends, the processing ends.

According to the present exemplary embodiment, in a case where data is transmitted between the AP 102 and the STA 103 via a plurality of links, information regarding each link that designates a link for an STA transmitting data to an AP can be stored into a Trigger frame to be transmitted to a plurality of links. Thus, an appropriate parameter can be designated in a Trigger frame for each link, and thereby it becomes unnecessary to transmit a Trigger frame a plurality of times, and it becomes possible to suppress overhead of communication.

In the first exemplary embodiment, the description has been given of an example in which a Trigger frame in which information designating a link for an STA transmitting data to an AP is stored in a Link Info field is transmitted.

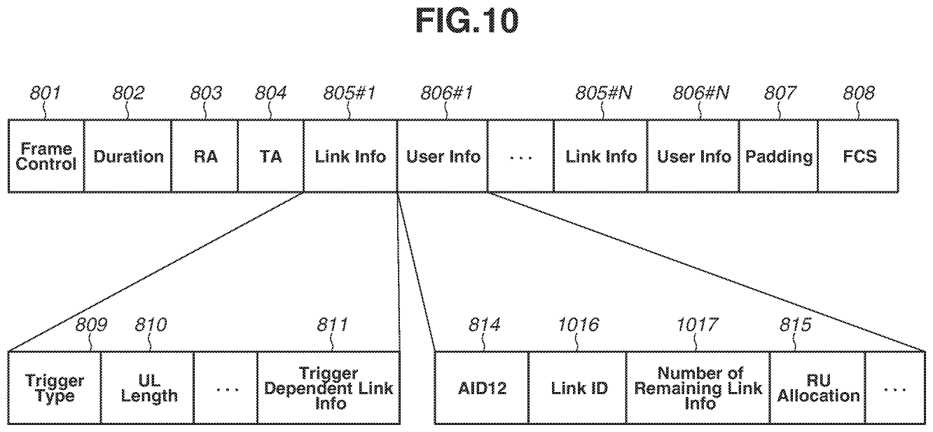

In a second exemplary embodiment, the description will be given of an example in which information designating a link for an STA transmitting data to an AP is stored in a User Info field, by using a Trigger frame illustrated in FIG. 10.

In the frame format illustrated in FIG. 10, a Link ID subfield 1016 and a Number of Remaining Link Info subfield 1017 are included in a User Info field 806.

The Link ID subfield 1016 in the User Info field 806 includes information regarding a link via which the STA 103 that establishes connection with the AP 102 transmits data. For example, in a case where an instruction is issued to transmit data via the first link operating in the 5 ch in the 2.4-GHz band, a value of the Link ID subfield 1016 is set to 1. A link number is allocated by the AP 102 when the AP 102 and the STA 103 establish connection, and given to the STA 103. The Link ID subfield 1016 prepares three bits. The number of bits to be prepared is not limited to this. For example, a subfield may be a two-bit, five-bit, or eight-bit subfield. As for parameters of a link designated in this Link ID subfield 1016, content of a Link Info field provided immediately anterior to the field is referred to.

The Number of Remaining Link Info subfield 1017 includes the remaining number of sets of a Link Info field and a User Info field included after the User Info field 1006. For example, if a value of the Number of Remaining Link Info subfield 1017 is 3, it is indicated that the set of the Link Info field and the User Info field is followed by three sets of Link Info and User Info. The Number of Remaining Link Info subfield 1017 prepares eight bits. The number of bits to be prepared is not limited to this. For example, the Number of Remaining Link Info subfield 1017 may be a two-bit or five-bit subfield.

The other fields of the Trigger frame are similar to those in the frame format illustrated in FIG. 8.

A transmission sequence of a Trigger frame, a data transmission and reception sequence, and a flowchart are similar to those in the first exemplary embodiment, and thus the description will be omitted.

According to the present exemplary embodiment, in a case where data is transmitted between the AP 102 and the STA 103 via a plurality of links, information regarding each link that designates a link for an STA transmitting data to an AP can be stored into a Trigger frame to be transmitted to a plurality of links. Thus, an appropriate parameter can be designated in a Trigger frame for each link, and thereby it becomes unnecessary to transmit a Trigger frame a plurality of times, and it becomes possible to suppress overhead of communication.

In the first and second exemplary embodiments, the description has been given of an example in which a Trigger frame is transmitted. In the Trigger frame, information designating a link for an STA transmitting data to an AP is stored in any one field of a Link Info field and a User Info field.

In the present exemplary embodiment, the description will be given of a frame format in which information designating a link for an STA transmitting data to an AP is stored into a Link Info field and a User Info field in a distributed manner.

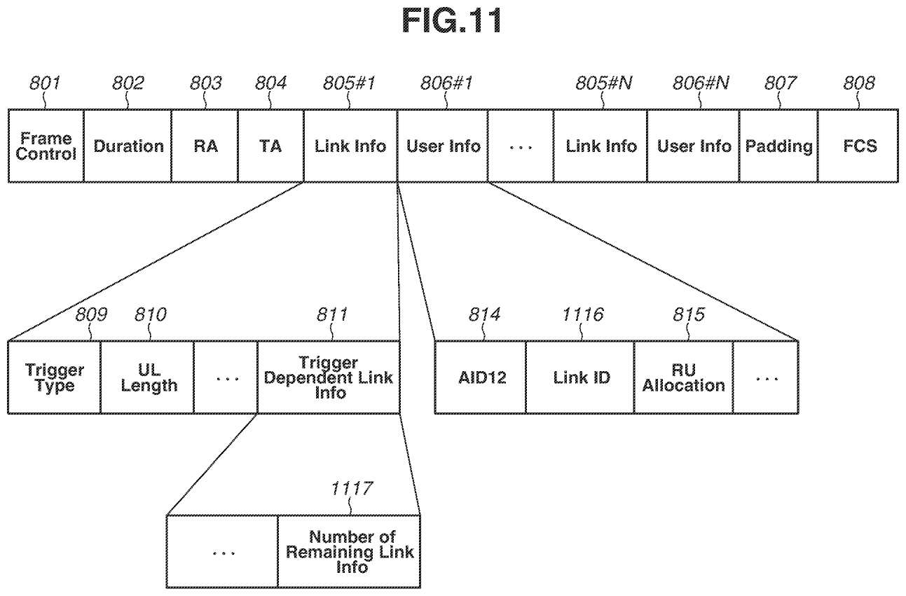

FIG. 11 illustrates an example of a frame format according to the present exemplary embodiment.

In this frame format, a Link Info field 805 includes a Number of Remaining Link Info subfield 1117, and a User Info field 806 includes a Link ID field 1116.

The Number of Remaining Link Info subfield 1117 includes the remaining number of sets of a Link Info field and a User Info field included in the Trigger frame after the User Info field 806.

In addition, the Link ID subfield 1115 in the User Info field 1106 includes information regarding a link via which a connected STA transmits data. For example, in a case where an instruction is issued to transmit data via the first link operating in the 5 ch in the 2.4-GHz band, the subfield value is set to 1.

The other fields of the Trigger frame are similar to those in the frame format illustrated in FIG. 8.

A transmission sequence of a Trigger frame, a data transmission and reception sequence, and a flowchart are similar to those in the first exemplary embodiment, and thereby the description will be omitted.

According to the present exemplary embodiment, in a case where data is transmitted between the AP 102 and the STA 103 via a plurality of links, information regarding each link that designates a link for an STA transmitting data to an AP can be stored into a Trigger frame to be transmitted to a plurality of links. Thus, an appropriate parameter can be designated in a Trigger frame for each link, and therefore it becomes unnecessary to transmit a Trigger frame a plurality of times, and it becomes possible to suppress overhead of communication.

In addition, a Link Info field may include a Link ID field and a User Info field may include a Number of Remaining Link Info field. The name of fields is not limited to the above-described names, and a different name may be used.

Furthermore, parameter information of each link is transmitted by using a Link Info field, but a notification method is not limited to this. The parameter information may be included in a field of a Trigger frame that complies with the IEEE 802.11ax. For example, information equivalent to a Link Info field may be included in a Common Info field.

In addition, a recording medium on which a program code of software for implementing the above-described function is recorded may be supplied to a system or an apparatus, and a computer (CPU, MPU) of the system or the apparatus may read out and execute the program code stored in the recording medium. In this case, the program code itself read out from a storage medium implements the function of the above-described exemplary embodiment, and a storage medium storing the program code forms the above-described apparatus.

As a storage medium for supplying the program code, it is possible to use, for example, a flexible disk, a hard disk, an optical disk, a magneto-optical disk, a CD-ROM, a CD-R, a magnetic tape, a nonvolatile memory card, a ROM, a DVD, or the like.

In addition, not only the above-described function is implemented by a computer executing a read program code, but also an OS operating on the computer may implement the above-described function by performing a part or all of actual processing based on an instruction of the program code.

Furthermore, a program code read out from a storage medium is written into a function expansion board inserted into a computer, or a memory included in a function expansion unit connected to the computer. Based on an instruction of the program code, the function expansion board or a CPU included in the function expansion unit may perform a part or all of actual processing and implement the above-described function.

The present invention can also be implemented by processing of supplying a program for implementing one or more functions of the above-described exemplary embodiment, to a system or an apparatus via a network or a storage medium, and one or more processors in a computer of the system or the apparatus reading out and executing the program. In addition, the present invention can also be implemented by a circuit (for example, application specific integrated circuit (ASIC)) that implements one or more functions.

The present invention is not limited to the above-described exemplary embodiments, and various changes and modifications can be made without departing from the spirit and the scope of the present invention. Accordingly, the following claims are appended to publicize the scope of the present invention.

According to the present invention, it is possible to suppress communication overhead attributed to the transmission of a Trigger frame when Multi-Link communication is performed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
an establishment unit configured to establish connection with a different communication apparatus via a plurality of links; and
a transmission unit configured to transmit, when connection with the different communication apparatus is established by the establishment unit via the plurality of links, a Trigger frame being a Trigger frame defined by an Institute of Electrical and Electronics Engineers (IEEE) 802.11 standard, which is transmitted to the different communication apparatus, and in which a set of a Common Info field and a User Info field in the Trigger frame is included for each link established by the establishment unit.

2. The communication apparatus according to claim 1, further comprising a receiving unit configured to receive data from the different communication apparatus in response to the transmission unit transmitting the Trigger frame,
wherein, in a case where data has been received by the receiving unit from the different communication apparatus via a first link and a second link, the communication apparatus transmits a Trigger frame indicating that data has been received, via the first link.

3. The communication apparatus according to claim 2, wherein the Trigger frame indicating that data has been received is Block Acknowledgement (Ack) complying with an IEEE 802.11 standard series.

4. The communication apparatus according to claim 2, wherein the Common Info field and the User Info field of the Trigger frame include link information and channel information as information for executing communication via the first link and information for executing communication via the second link.

5. The communication apparatus according to claim 2, wherein information for executing communication via the first link and information for executing communication via the second link are stored in a Common Info field or a User Info field of the Trigger frame.

6. The communication apparatus according to claim 2, wherein information for executing communication via the first link and information for executing communication via the second link are stored in a Common Info field and a User Info field of the Trigger frame.

7. The communication apparatus according to claim 1, wherein the communication apparatus operates as an access point (AP) complying with an IEEE 802.11 standard series.

8. A communication method of a communication apparatus, the communication method comprising:
establishing connection with a different communication apparatus via a plurality of links; and
transmitting, when connection with the different communication apparatus is established by the establishing via the plurality of links, a Trigger frame being a Trigger frame defined by an IEEE 802.11 standard, which is transmitted to the different communication apparatus, and in which a set of a Common Info field and a User Info field in the Trigger frame is included for each link established by the establishing.

9. A storage medium storing a program for causing a computer to function as each unit of the communication apparatus according to claim 1.
